(19) United States
(12) Patent Application Publication
(10) Pub. No.: US 2008/0308598 A1
(43) Pub. Date: Dec. 18, 2008

(54) Stapling device

(76) Inventor: Chun Yuan Chang, Taipei (TW)

Correspondence Address: CHARLES E. BAXLEY, ESQUIRE, 90 JOHN STREET, SUITE 309, NEW YORK, NY, 10038, US

(21) Appl. No.: 12/228,362

(22) Filed: Aug. 11, 2008

Related U.S. Application Data
(63) Continuation-in-part of application No. 11/518,031, filed on Sep. 11, 2006.

(51) Int. Cl. B25C 5/11

(52) U.S. Cl. 227/128; 227/132

(57) ABSTRACT

A stapling device includes a housing and a cover pivotally attached to a base member, a staple drive plate received in the housing for staple driving purpose, a lever attached in the housing and engaged between the staple drive plate and the cover, a spring for biasing the cover away from the housing, a spring device attached to the housing for biasing the staple drive plate, and a follower slidably received in the housing for selectively latching the cover to the housing and for preventing the cover from being moved and depressed toward the housing when the housing and base member are rotated away from each other and for preventing the staple drive plate from being triggered or actuated inadvertently.

The present invention is a continuation-in-part of U.S. patent application Ser. No. 11/518,031, filed 11 Sep. 2006, pending.

### BACKGROUND OF THE INVENTION

1. Field of the Invention

The present invention relates to a stapling device, and more particularly to a stapling device having a safety locking device for selectively locking the stapling device and for preventing the striking plate of the stapling device from being triggered or actuated inadvertently.

2. Description of the Prior Art

Various kinds of typical stapling devices have been developed and comprise a base member having an anvil plate, a staple magazine member and a driving member provided with a staple drive plate. A staple guide member and a staple feeder are coupled to the driving member, to feed the staples toward the driving member, and to allow the staples to be suitably driven or hammered by the driving member.

For example, U.S. Pat. No. 6,918,525 to Marks discloses one of the typical stapling devices comprising a multi function base provided with a sloped front, and the base surrounds the rear of the stapler body to provide a smooth exterior so that the device is natural to use both horizontally and vertically, and a re-set spring provides a smooth re-set action as the handle is raised.

However, normally, the typical stapling devices have no safety locking device for selectively locking the stapling device and for preventing the striking plate of the stapling device from being triggered or actuated or operated inadvertently, particularly, the striking plate of the stapling device may be triggered or actuated or operated inadvertently when the staple magazine member is opened relative to the base.

The present invention has arisen to mitigate and/or obviate the afore-described disadvantages of the conventional staplers or stapling devices.

### SUMMARY OF THE INVENTION

The primary objective of the present invention is to provide a stapling device including a safety locking device for selectively locking the stapling device and for preventing the striking plate of the stapling device from being triggered or actuated or operated inadvertently.

The other objective of the present invention is to provide a stapling device including a structure for allowing the stapling device to be effectively actuated or operated by the user.

In accordance with one aspect of the invention, there is provided a stapling device comprising a base member, a housing and a cover pivotally attached to the base member, and the housing including a passage formed therein, the cover including a channel formed therein, a staple drive plate slidably received in the passage of the housing and movable relative to the housing for staple driving purpose, the staple drive plate including a cavity and at least one orifice formed therein, a lever pivotally attached in the housing and including a first end engaged with the cover, and including a second end engageable into the cavity of the staple drive plate and selectively disengageable from the cavity of the staple drive plate, a spring member disposed between the housing and the cover for biasing and moving the cover away from the housing, a spring device attached to the housing and including at least one leg engaged into the orifice of the staple drive plate for applying a spring biasing force to the staple drive plate, in order to bias and force the staple drive plate out through the passage of the housing and for staple driving purpose, and a follower slidably received in the housing and selectively aligned with the channel of the cover for selectively engaging into the channel of the cover and for allowing the cover to be moved and depressed toward the housing, and the cover being prevented from being moved and depressed toward the housing when the follower is disengaged from the channel of the cover.

The housing includes a spring element disposed between the housing and the follower for biasing and forcing the follower to move relative to the housing and for selectively moving and disengaging the follower from the channel of the cover. The follower includes an aperture formed therein for receiving the spring element.

The cover includes a bar for forming the channel of the cover and for selectively aligning with the follower when the follower is disengaged from the channel of the cover.

The housing includes a cavity formed therein, and the follower includes an extension extended therefrom and slidably engaged through the cavity of the housing and for selectively engaging with the base member.

The follower includes an inclined surface formed on the extension for selectively engaging with the base member and for allowing the extension and the follower to be selectively moved into the housing by the base member when the housing and the base member are moved and pivoted toward each other.

The spring device includes a groove formed therein and formed by the leg for slidably receiving the lever. The leg of the spring device includes a bent structure for forming a resilient structure to the leg. The housing includes a seat extended therefrom for engaging with the spring device.

The housing includes a pivot pin extended therefrom, and the lever includes an oblong hole formed therein for slidably and pivotally receiving the pivot pin and for pivotally attaching the lever in the housing with the pivot pin.

The cover includes a block extended therein and having a depression formed in the block, and the first end of the lever is engaged in the depression of the block.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a stapling device in accordance with the present invention;

FIG. 2 is another perspective view of the stapling device, in which a portion of the stapling device has been cut off for showing an inner structure of the stapling device;

FIG. 3 is a partial exploded of the stapling device;

FIGS. 4, 5 are enlarged partial perspective views illustrating the operation of the stapling device;

FIG. 6 is another enlarged partial perspective view illustrating the operation of the stapling device; and

FIG. 7 is a further perspective view illustrating the safety locking device of the stapling device.

### DETAILED DESCRIPTION OF THE PREFERRED EMBODIMENT

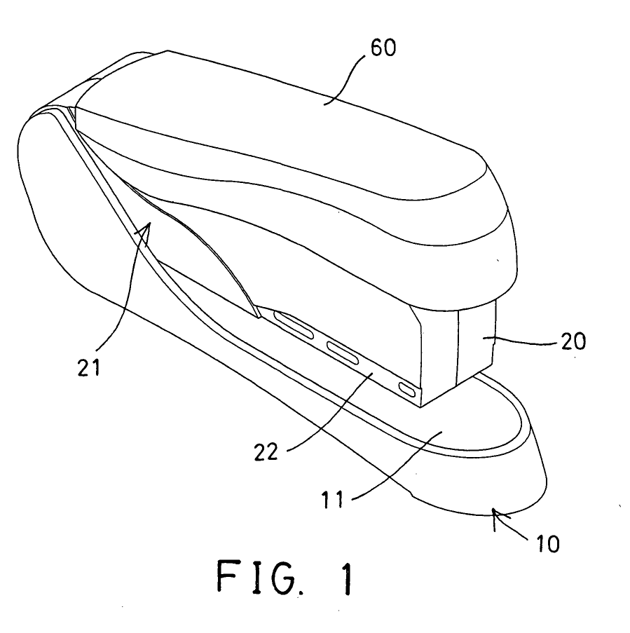

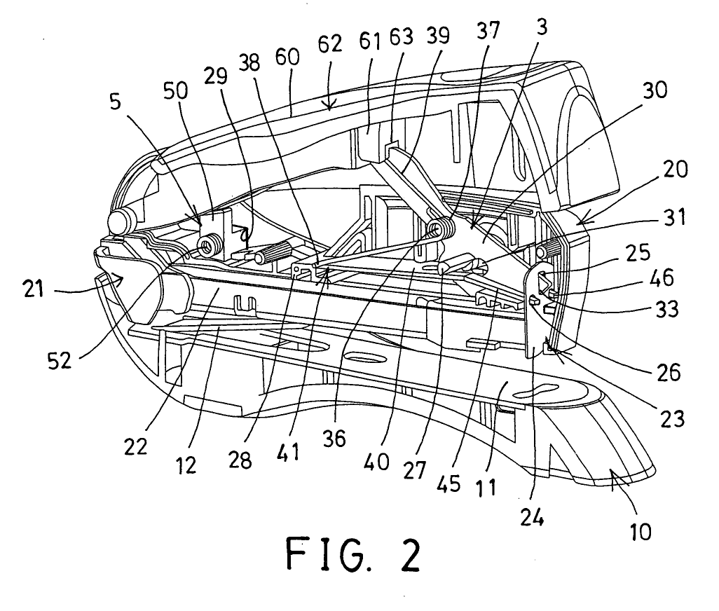

Referring to the drawings, and initially to FIGS. 1-3, a stapling device 1 in accordance with the present invention comprises a base member 10, an anvil plate 11 disposed in the upper portion of the base member 10 and having one or more inward staple guide depressions (not shown) formed in such as a front portion thereof, and having a spring arm 12 extended upward from the rear portion thereof (FIG. 2). A staple magazine or housing 20 includes a rear portion 21 rotatably or pivotally attached or secured to the base member 10 for rotatably securing the housing 20 to the base member 10, and for allowing the housing 20 to be pivoted or rotated relative to the base member 10. The staple magazine or housing 20 may include two housing members secured together by fasteners, latches (not shown), adhesive materials, or by welding processes, or the like.

A handle or cover 60 is attached or secured to the housing 20 and/or rotatably or pivotally attached or secured to the base member 10 for allowing the cover 60 to be pivoted or rotated relative to the base member 10 and/or the housing 20. The pivotal coupling of the housing 20 and/or the cover 60 to the base member 10 is typical and will not be described in further details. The housing 20 includes a magazine member 22 formed or provided on the lower portion thereof for receiving the staples (not shown), and includes a passage 23 formed in the front portion thereof for slidably receiving a staple drive plate 24 therein which includes a cavity 25 and two orifices 26 formed therein, and includes a pivot pin 27 laterally extended therefrom (FIG. 2), and includes a swelling or seat 28 extended or provided in the housing 20.

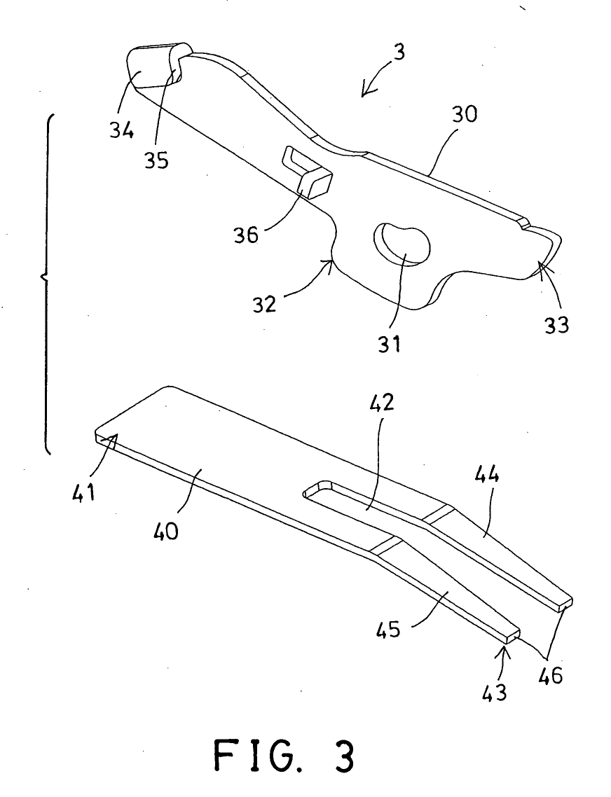

An actuating means or device 3 includes a lever 30 having an oblong hole 31 formed in the front or middle portion 32 thereof (FIG. 3) for slidably and rotatably or pivotally receiving the pivot pin 27 and for rotatably or pivotally attaching or securing the lever 30 in the housing 20 with the pivot pin 27, and the lever 30 includes a front end 33 engageable into and also disengageable from the cavity 25 of the staple drive plate 24. For example, the lever 30 is arranged to allow the front end 33 of the lever 30 to be engaged into the cavity 25 of the staple drive plate 24 when the front end 33 of the lever 30 is moved or rotated downwardly relative to the housing 20 (FIG. 2), and to be disengaged from the cavity 25 of the staple drive plate 24 when the front end 33 of the lever 30 is rotated upwardly relative to the housing 20 (not shown).

The cover 60 includes a block 61 extended or provided in the middle portion 62 thereof and having a depression 63 formed in the block 61, and the lever 30 includes a rear end 34 slidably engaged in the depression 63 of the block 61 of the cover 60 for allowing the lever 30 to be rotated or pivoted relative to the housing 20 by the cover 60 when the cover 60 is depressed or moved toward or relative to the housing 20, and for allowing the front end 33 of the lever 30 to be moved or rotated upwardly relative to the housing 20 and to be disengaged from the cavity 25 of the staple drive plate 24 when the cover 60 is depressed toward the housing 20. The lever 30 includes a slot 35 formed in the rear end 34 thereof, and includes a protrusion 36 extended from the middle portion 32 thereof. A spring member 37 may be attached or engaged onto the protrusion 36, and may have one end 38 rested on or secured to or engaged with the seat 28 of the housing 20, and the other end 39 attached or engaged with the cover 60 for biasing or moving the cover 60 away from the housing 20.

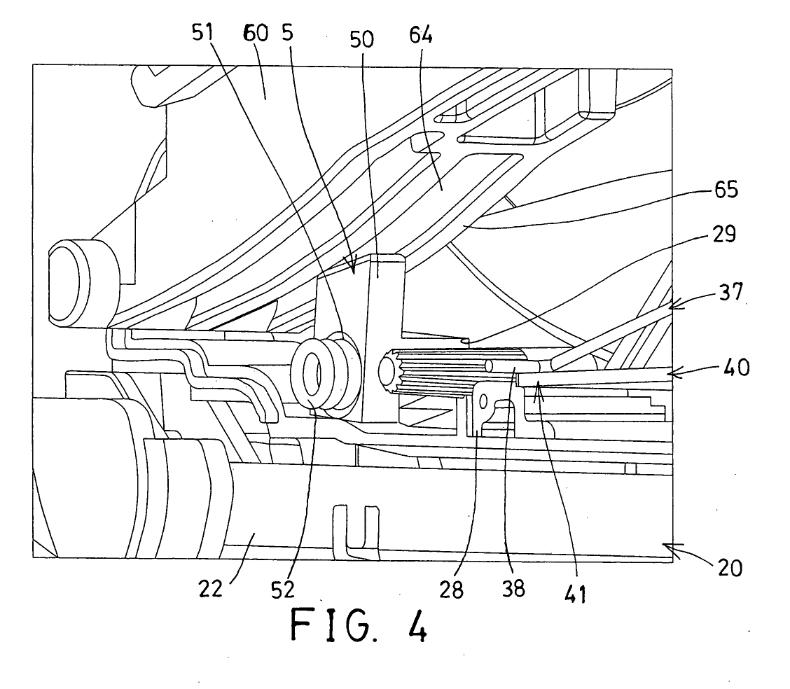

Another spring blade or spring device 40 includes one end or inner end 41 attached or engaged the seat 28 of the housing 20, and includes a groove 42 formed in the other end or outer end 43 thereof and formed or defined between two legs 44, 45 for slidably receiving the middle portion 32 of the lever 30, and the legs 44, 45 include an identical structure and each include a bent structure for forming a spring or resilient structure to the legs 44, 45, and each include a front or free end 46 engage into the orifices 26 of the staple drive plate 24 for applying a spring biasing force to the staple drive plate 24, in order to bias or spring the staple drive plate 24 downwardly and/or outwardly through the passage 25 of the housing 20, and for staple driving purposes. As shown in FIGS. 4 and 5, the cover 60 includes a channel 64 formed therein and formed or defined by two bars 65.

A safety locking device 5 include a slide or follower 50 slidably received or attached to the housing 20, the follower 50 is aligned with the channel 64 of the cover 60 for selectively engaging into the channel 64 of the cover 60 (FIG. 4) and for allowing the cover 60 to be moved or depressed toward the housing 20, and the follower 50 includes an aperture 51 formed therein for receiving a further spring element 52 which is disposed or engaged between the housing 20 and the follower 50 for biasing or forcing the follower 50 to move relative to the housing 20 and for selectively moving or disengaging the follower 50 from the channel 64 of the cover 60 (FIG. 5) and for selectively aligning the follower 50 with one of the bars 65 and thus for preventing the cover 60 from being moved or depressed toward the housing 20, and thus for preventing the staple drive plate 24 of the stapling device from being triggered or actuated or operated inadvertently.

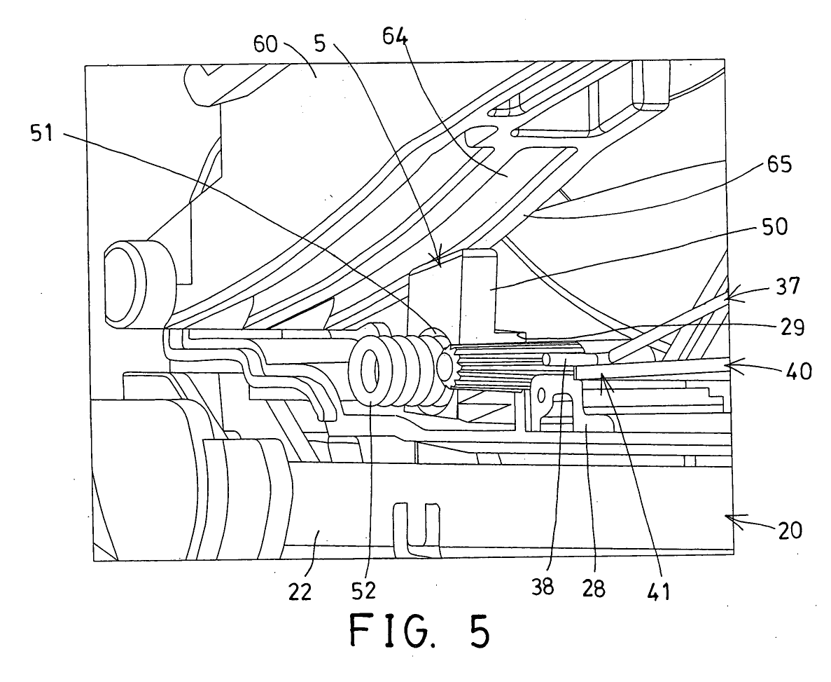

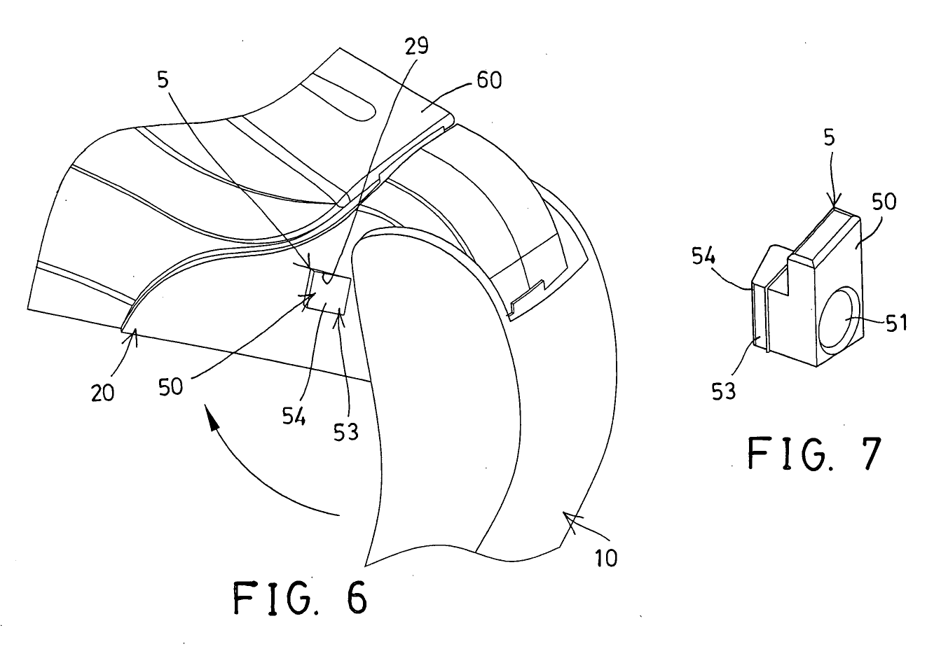

The follower 50 includes a block or extension 53 laterally extended therefrom (FIG. 7) for slidably engaging through a cavity 29 of the housing 20 (FIGS. 2, 4-6) and for selectively engaging with the base member 10 (FIG. 6), and includes an inclined surface 54 formed on the extension 53 for selectively engaging with the base member 10 and for allowing the extension 53 and the follower 50 to be selectively moved into the housing 20 by the base member 10 when the housing 20 and the base member 10 are moved or pivoted or rotated toward each other. On the contrary, when the housing 20 and the base member 10 are moved or pivoted or rotated away from each other (FIG. 6), the base member 10 is not contacted or engaged with the extension 53 of the follower 50 and the extension 53 of the follower 50 may be moved or forced out of the cavity 29 of the housing 20, and the follower 50 may be disengaged from the channel 64 of the cover 60 by the spring element 52, such that the cover 60 may be prevented from being moved or depressed toward the housing 20 when the housing 20 and the base member 10 are not moved or pivoted or rotated toward each other.

In operation, as shown in FIG. 2, when the cover 60 is depressed or rotated downwardly relative to or toward the housing 20, the other or rear end 34 of the lever 30 may be actuated or depressed by the cover 60, to force and to disengage the front end 33 of the lever 30 from the cavity 25 of the staple drive plate 24, and thus to allow the staple drive plate 24 to be biased or forced downwardly and/or outwardly through the passage 25 of the housing 20 to drive or hammer the staples by the spring device 40. When the cover 60 is released, the spring member 37 may bias and rotate the lever 30 relative to the housing 20 and the cover 60, to bias and force the front end 33 of the lever 30 to engage into the cavity 25 of the staple drive plate 24 again, and to the original or normal position ready for further staple driving operation. The spring arm 12 of the base member 10 may be used to bias the housing 20 upwardly away from the base member 10 to the original or normal position.

As shown in FIG. 6, when the housing 20 and the base member 10 are moved or pivoted or rotated away from each other, the extension 53 of the follower 50 may be moved or forced out of the cavity 29 of the housing 20 by the spring element 52, and the follower 50 may be disengaged from the channel 64 of the cover 60 by the spring element 52, such that the cover 60 may be prevented from being moved or depressed toward the housing 20 when the housing 20 and the base member 10 are not moved or pivoted or rotated toward each other and such that the staple drive plate 24 of the stapling device may be prevented from being triggered or actuated or operated inadvertently by the cover 60.

Accordingly, the stapling device in accordance with the present invention includes a safety locking device for selectively locking the stapling device and for preventing the striking plate of the stapling device from being triggered or actuated or operated inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A stapling device comprising:
a base member,
a housing and a cover pivotally attached to said base member, and said housing including a passage formed therein, said cover including a channel formed therein,
a staple drive plate slidably received in said passage of said housing and movable relative to said housing for staple driving purpose, said staple drive plate including a cavity and at least one orifice formed therein,
a lever pivotally attached in said housing and including a first end engaged with said cover, and including a second end engageable into said cavity of said staple drive plate and selectively disengageable from said cavity of said staple drive plate,
a spring member disposed between said housing and said cover for biasing and moving said cover away from said housing,
a spring device attached to said housing and including at least one leg engaged into said at least one orifice of said staple drive plate for applying a spring biasing force to said staple drive plate, in order to bias and force said staple drive plate out through said passage of said housing and for staple driving purpose, and
a follower slidably received in said housing and selectively aligned with said channel of said cover for selectively engaging into said channel of said cover and for allowing said cover to be moved and depressed toward said housing, and said cover being prevented from being moved and depressed toward said housing when said follower is disengaged from said channel of said cover.

2. The stapling device as claimed in claim 1, wherein said housing includes a spring element disposed between said housing and said follower for biasing and forcing said follower to move relative to said housing and for selectively moving and disengaging said follower from said channel of said cover.

3. The stapling device as claimed in claim 2, wherein said follower includes an aperture formed therein for receiving said spring element.

4. The stapling device as claimed in claim 1, wherein said cover includes a bar for forming said channel of said cover and for selectively aligning with said follower when said follower is disengaged from said channel of said cover.

5. The stapling device as claimed in claim 1, wherein said housing includes a cavity formed therein, and said follower includes an extension extended therefrom and slidably engaged through said cavity of said housing and for selectively engaging with said base member.

6. The stapling device as claimed in claim 5, wherein said follower includes an inclined surface formed on said extension for selectively engaging with said base member and for allowing said extension and said follower to be selectively moved into said housing by said base member when said housing and said base member are moved and pivoted toward each other.

7. The stapling device as claimed in claim 1, wherein said spring device includes a groove formed therein and formed by said at least one leg for slidably receiving said lever.

8. The stapling device as claimed in claim 1, wherein said at least one leg of said spring device includes a bent structure for forming a resilient structure to said at least one leg.

9. The stapling device as claimed in claim 1, wherein said housing includes a seat extended therefrom for engaging with said spring device.

10. The stapling device as claimed in claim 1, wherein said housing includes a pivot pin extended therefrom, and said lever includes an oblong hole formed therein for slidably and pivotally receiving said pivot pin and for pivotally attaching said lever in said housing with said pivot pin.

11. The stapling device as claimed in claim 1, wherein said cover includes a block extended therein and having a depression formed in said block, and said first end of said lever is engaged in said depression of said block.
